(19) United States
(12) Patent Application Publication
(10) Pub. No.: US 2018/0058317 A1
(43) Pub. Date: Mar. 1, 2018

(54) SYSTEM AND METHOD FOR REDUCED TURBINE DEGRADATION BY CHEMICAL INJECTION

(71) Applicant: General Electric Company, Schenectady, NY (US)

(72) Inventors: Jason Brian Shaffer, Tempe, AZ (US); Alston Ilford Scipio, Mableton, GA (US); Sanji Ekanayake, Mableton, GA (US); Lewis Berkley Davis, JR., Niskayuna, NY (US); Edwin Wu, Houston, TX (US)

(21) Appl. No.: 15/245,244

(22) Filed: Aug. 24, 2016

(51) Int. Cl. F02C 3/30; F02C 3/04; F23R 3/28

(52) U.S. Cl. CPC F02C 3/305; F02C 3/04; F05D 2270/08; F05D 2210/12; F23R 3/28

(57) ABSTRACT

A gas turbine injection system having a gas turbine with an inlet section, a compressor section, at least one combustor in a combustion section, and a turbine section is disclosed. Air supply piping, water supply piping, and chemical reactant supply piping is in fluid communication with the injection system. A mixing chamber is in fluid communication with at least one of the water supply piping, air supply piping, and the chemical reactant supply piping to produce a chemical mixture. Chemical mixture supply piping is in fluid communication with the mixing chamber and at least one spray nozzle configured to selectively combine the chemical mixture with the air and inject an atomized chemical mixture into at least one section of the turbine.

### FIELD OF THE DISCLOSURE

This disclosure generally relates to gas turbine chemical injection and cleaning systems and more specifically to systems and methods for reducing gas turbine performance degradation by injecting chemical mixture using existing casing openings in the turbine.

### BACKGROUND OF THE DISCLOSURE

Gas turbines are designed with the ability to utilize a variety of fuels ranging from gas to liquid, at a wide range of temperatures, pressures, and fuel compositions. As a gas turbine operates, contaminants may collect and buildup layers coating the blades of the compressor and turbine sections leading to reduced performance. This contamination can take the form of calcium-magnesium alumino-silicates (CMAS) that degrade the thermal barrier coatings of the turbine components and thus reducing part life. The contaminants can be contributed by both air and fuel.

For airborne contaminants, these solid and gaseous particles lead to deposits on the compressor blades resulting in impaired aerodynamic conditions and consequently reduced efficiency of the compressor. These contaminants may even be passed further along to the turbine section causing similar air blockage and even hot corrosion of the turbine parts. Costs associated with degraded performance and part replacement due to contamination are significant. A method and application for cleaning air before entry into the compressor is known from, for example EP 0350272. This patent involves the use of an inlet housing comprised of a series of air scrubbers, water/solvent injection stage, coalescing mediums, and moisture separators to remove contaminants prior to sending air to the gas turbine compressor section.

Even with the best available inlet air filtration system and methods, undesired particulates still make it into the compressor resulting in contamination of the downstream sections. Extensive teachings exist around cleaning methods, devices, and systems around the compressor section of a gas turbine. Traditional compressor water wash systems consist of a system of nozzles which spray wash/rinse fluid upstream of the compressor inlet, example patent documents include U.S. Pat. No. 8,337,630 and U.S. Pat. No. 5,193,976. These systems can be operated both online and offline. Subsequent inspections have shown that only the first three to four rows of blades achieve satisfactory cleaning through these traditional inlet water wash methods. Patent publication WO 2007/102738 addresses this issue by utilizing the compressor borescope openings for injection of detergent to downstream stages of the compressor for cleaning. Also, patent publication US 2014/0124007 teaches utilizing existing compressor extraction piping to deliver cleaning solutions to downstream stages of the compressor.

Besides airborne contaminants, fuel is also a main contributor to contaminants that occur downstream of the compressor. Extensive teachings exist around methods, devices, and systems related to fuel additives and injection of fluids into the combustor to affect combustion byproducts. In particular, blending a magnesium solution to ash-bearing fuel has been proven to substantially slow the rate of deposition and blockage of turbine stage-1 nozzle area extending periods between required water washes by 80 hours, taught for example in WO 2000/069996. Other delivery methods and injection methods of fuel additives to the combustion system of a gas turbine are taught in patent publications US 2010/0242490, US 2011/0314833, EP 0717813, and EP 0994932.

Commonly assigned co-pending U.S. patent application Ser. No. 15/058,305 to Montagne et al., filed Mar. 2, 2016, teaches that the use of magnesium as an inhibitor leads to formation of magnesium vanadate (Mg₃V₂O₈), which has a relatively high melting point (1074° C.). This is sufficient for some gas turbines but limits its use for higher-firing temperature machines. The high excess molar ratio of Mg/V=6.3:1 conventionally used results in the formation of high MgSO₄-content ash from the excess magnesium.

Magnesium is ineffective as an inhibitor when lead, nickel, sodium, or potassium is present in the fuel in addition to the vanadium. Although lead is not typically seen in heavy fuel oil, when present, it may form a low melting point lead oxide (888° C.), which is very corrosive. When sodium and/or potassium are present with vanadium in a sulfur-containing fuel, the amount of magnesium needed to inhibit the vanadium is even higher and the effective molar ratio of Mg/V may be as high as 11:1. When magnesium is used as the inhibitor, the generated ash has a low density of about 2.36 g/cc, leading to a large volume of ash generated. In any case, use of magnesium as an inhibitor results in high deposit rate on the hot gas path, fast fouling, and losses in gas turbine performance.

While vanadium is effectively generally neutralized by magnesium-based inhibitors, the volume of ash generated is high and is directly proportional to the amount of vanadium present. The reaction chemistry for magnesium inhibition has a Mg/V=3 mass balance such that 10.6 moles of reaction product is formed for every mole of vanadium present, giving rise to a large volume of ash deposition, which chokes the flow, and reduces power output, in turn driving frequent water wash cycles. Even though it is technically achievable, neutralization of vanadium above 100 ppm in the fuel would require a gas turbine water wash so frequently to remove deposits as to be impractical.

Currently, there is no method and system for injecting chemical agents into at least one section of the turbine for the purpose of reducing contamination buildup, sometimes referred to as fouling. U.S. Pat. No. 5,679,174 teaches drilling holes into the turbine casing and inserting a tube to spray high pressure water/solvents on upper portion of trailing edge and leading edge of turbine blades to directly remove debris buildup. The drilled holes in the turbine casing are then sealed up. This invention is not practical in the field as many plant operators would not approve drilling holes through the turbine casing for temporary cleaning while introducing risk of damaging expensive turbine components.

### BRIEF DESCRIPTION OF THE DISCLOSURE

Aspects and advantages of the disclosure will be set forth in part in the following description, or may be obvious from the description, or may be learned through practice of the disclosure.

An embodiment of the gas turbine injection system disclosed herein can have a gas turbine with an inlet section, a compressor section, at least one combustor in a combustion section, and a turbine section. Air supply piping is in fluid communication with a supply of air and at least one spray nozzle. Water supply piping is in fluid communication with a supply of water. Chemical reactant supply piping is in fluid communication with the supply of a chemical reactant. A mixing chamber is in fluid communication with the water supply piping and the chemical reactant supply piping. The mixing chamber is configured to receive water from the water supply piping and the chemical reactant from the chemical reactant supply piping to produce a chemical mixture. Chemical mixture supply piping is in fluid communication with the mixing chamber and the at least one spray nozzle configured to selectively combine the chemical mixture with the air and inject an atomized chemical mixture into at least one section of the turbine.

Another embodiment of the gas turbine injection system disclosed herein can have a gas turbine having an inlet section, a compressor section, at least one combustor in a combustion section, and a turbine section. Air supply piping is in fluid communication with a supply of air and a mixing chamber. Water supply piping is in fluid communication with a supply of water and the mixing chamber. Chemical reactant supply piping is in fluid communication with the supply of a chemical reactant and the mixing chamber. The mixing chamber is configured to mix the air, water, and chemical reactant to produce a chemical mixture fed in chemical mixture supply piping to at least one spray nozzle configured to inject the chemical mixture into at least one section of the turbine.

A chemical injection method for reducing turbine degradation is also disclosed herein having the steps of; generating a chemical mixture in a mixing chamber, and injecting the chemical mixture having at least one yttrium-containing compound to at least one section of a gas turbine. The method uses a gas turbine injection system having air supply piping in fluid communication with a supply of air and at least one spray nozzle, water supply piping in fluid communication with a supply of water, and chemical reactant supply piping in fluid communication with the supply of a chemical reactant. The mixing chamber is in fluid communication with the water supply piping and the chemical reactant supply piping. The mixing chamber is configured to receive water from the water supply piping and the chemical reactant from the chemical reactant supply piping to produce the chemical mixture. Chemical mixture supply piping is in fluid communication with the mixing chamber and the at least one spray nozzle, with the at least one spray nozzle configured to selectively combine the chemical mixture with the air and inject an atomized chemical mixture into at least one section of the turbine.

These and other features, aspects and advantages of the present disclosure will become better understood with reference to the following description and appended claims. The accompanying drawings, which are incorporated in and constitute a part of this specification, illustrate embodiments of the disclosure and, together with the description, serve to explain the principles of the disclosure.

### BRIEF DESCRIPTION OF THE DRAWINGS

A full and enabling disclosure, including the best mode thereof, directed to one of ordinary skill in the art, is set forth in the specification, which makes reference to the appended figures, in which:

FIG. 1 is a schematic of an exemplary gas turbine;

FIG. 2 is a schematic of an exemplary embodiment of a chemical injection system serving a gas turbine;

FIG. 3 is a schematic of the chemical injection system spray nozzles installed at multiple stages of the turbine in accordance with an embodiment of the invention;

FIG. 4 is a schematic embodiment with the chemical mixture of air, water, and chemical reactant mixed in the mixing chamber;

FIGS. 5A and 5B show embodiments of the spray nozzles using atomizing-type nozzles fed by a pressurized chemical mixture and a siphoned chemical mixture.

Repeat use of reference characters in the present specification and drawings is intended to represent the same or analogous features or elements of the present disclosure.

### DETAILED DESCRIPTION OF THE DISCLOSURE

Reference now will be made in detail to embodiments of the disclosure, one or more examples of which are illustrated in the drawings. Each example is provided by way of explanation of the disclosure, not limitation of the disclosure. In fact, it will be apparent to those skilled in the art that various modifications and variations can be made in the present disclosure without departing from the scope or spirit of the disclosure. For instance, features illustrated or described as part of one embodiment can be used with another embodiment to yield a still further embodiment. Thus, it is intended that the present disclosure covers such modifications and variations as come within the scope of the appended claims and their equivalents.

As used herein, the terms “first”, “second”, and “third” may be used interchangeably to distinguish one component from another and are not intended to signify location, or importance of the individual components. The terms “upstream” and “downstream” refer to the relative direction with respect to fluid flow in a fluid pathway. For example, “upstream” refers to the direction from which the fluid flows, and “downstream” refers to the direction to which the fluid flows. The term “radially” refers to the relative direction that is substantially perpendicular to an axial centerline of a particular component and/or substantially perpendicular to an axial centerline of the turbomachine, and the term “axially” refers to the relative direction that is substantially parallel and/or coaxially aligned to an axial centerline of a particular component and/or to an axial centerline of the turbomachine, and the term “circumferentially” refers to the relative direction that is substantially parallel to the circumference of a particular component and/or substantially parallel to the turbomachine annular casing element.

Although an industrial, marine, or land based gas turbine is shown and described herein, the present disclosure as shown and described herein is not limited to a land based and/or industrial, and/or marine gas turbine unless otherwise specified in the claims. For example, the disclosure as described herein may be used in any type of turbine including but not limited to an aero-derivative turbine or marine gas turbine.

A chemical injection system for use with a turbine and/or combustor section having one or more existing openings typically used for blade and/or combustor inspection is disclosed herein. The chemical injection system may include a water source, an air source, a chemical agent, a mixing chamber in communication with any combination of the above mentioned sources, and a retracting nozzle manifold and/or retracting nozzles in communication with the mixing chamber.

This disclosure provides a solution to reducing turbine degradation by installing retracting nozzles and/or manifolds to the turbine/combustor casings that inject a predetermined chemical mixture at a specified pressure and temperature directly into the various stages of the turbine/combustor internals using existing borescope openings and the like to inject chemical additives during both offline and online operation. The chemical mixture sprayed into the turbine casing is directed at the turbine rotor blades and stationary nozzles to protect or restore hot gas path integrity. The chemical mixture sprayed into the combustor can use late lean injection system ports or other suitable existing combustor casing penetrations. The chemical mixture can also be added to the late lean injection fuel feed and/or the combustor premix or purge air manifolds. The chemical mixture is a predetermined mixture and can be interchanged as required based on known or expected environmental reactants. Some problems involving vanadium, and other fuel impurities, buildup with heavy fuel oil can be solved herein using a magnesium-based or yttrium-based chemical mixture injected to control high temperature corrosion and reduce the vanadium buildup created by the fuel source. Also, corrosive hardware damage with gas turbines operating in acidic environments can be minimized using a neutralizing amine compound injected to reduce corrosion and acidic deposit formation. Also, the rate of corrosion in turbine hardware can be reduced using a polyamine solution injected to form a corrosion inhibiting film on the turbine internals.

Yttrium-containing chemical mixtures of the present disclosure can provide a lower volume of ash generated during corrosion inhibition compared to magnesium ash generation; can allow for longer time intervals between water wash cycles; can provide a higher melting point vanadium reaction product; can provide ash products that are highly refractory, that do not tend to stick on the hot gas path, that are not fully sintered, and that are more easily mechanically washable than magnesium ash products; inhibit corrosion caused by fuel impurities, including vanadium, lead, and nickel; can promote the formation of lead sulfates from any lead impurities present rather than lead oxide; can promote the formation of nickel sulfate from any nickel impurities present; can include forms of yttrium more readily available through existing supply chains and more cost-effective than organometallic forms of yttrium; and can allow higher gas turbine firing temperatures; or a combinations thereof.

In some embodiments, the yttrium may be in the form of any soluble or suspended yttrium source. In some embodiments, the yttrium is in the form of an inorganic salt, an inorganic salt powder, an inorganic salt dissolved in water as a nitrate or a sulfate, or an inorganic salt in a fuel-soluble form. The forms of the inorganic salts of yttrium or yttrium oxide particles suspended in water are more commonly-available and less expensive than organometallic forms. In some embodiments, the yttrium is in the form of a hydrocarbon-based slurry, where the viscosity of the medium may be used to stabilize the suspension, rather than a water-based material.

The yttrium acts as an inhibitor and can accomplish one or more of the following: i) a conversion of corrosive compounds in the hot gas path into high melting point frangible salts that permit higher firing temperatures, ii) a reduction of the volume of ash generated by using higher valence compounds that form denser reaction products (about 2.5 moles of ash at about 4.2 gm/cc compared to about 10.6 moles of ash at about 2.36 gm/cc), leading to longer time intervals between water wash cycles, iii) driving lead to form lead sulfate instead of a corrosive oxide; and iv) driving nickel to form nickel sulfates so that nickel constituents in the ash are water soluble.

The yttrium-vanadium reaction product, YVO₄, (1810° C.) has a much higher melting point than the magnesium-vanadium reaction product, Mg₃V₂O₈, (1074° C.). This allows for ash products that are not fully sintered, making them more easily washable through mechanical means. The yttrium ash products are also highly refractory and do not tend to stick on the hot gas path. As a result of the better inhibitor chemistry, a lower volume of ash having a higher melting point is produced, lead corrosion is made more benign, and washability with an injection cleaning system is achieved by ensuring formation of nickel sulfate from nickel constituents. Nickel sulfate up to exposure temperatures of 1066° C. is water-soluble.

Entrainment of yttrium-based inorganic salts and oxides along with sulfur already present in the fuel neutralizes the effect of vanadium and lead in the fuel. In some embodiments, yttrium salts decompose and oxidize to release yttrium oxide (Y₂O₃), which combines with vanadium oxide to form yttrium vanadate (YVO₄). In other embodiments, sub-micron particles of yttrium oxide (Y₂O₃), entrained in water with a compatibilizer forms the chemical mixture to neutralize the effect of vanadium. In some embodiments, the compatibilizer is a surfactant. Appropriate surfactants may include, but are not limited to, ethoxylates with alcohol and phenyl groups that are free of sodium. In some embodiments, the compatibilizer is a surface functionalization of the sub-micron particle. Appropriate surface functionalizations may include, but are not limited to, silanizations.

The yttrium-containing compound can be in the form of a nanosuspension in the fuel prior to introduction of the fuel to the hot gas path. In some embodiments, the yttrium-containing compound is in an aqueous phase in the form of an emulsion with the fuel when mixed with the fuel prior to introduction of the fuel to the hot gas path.

The yttrium inorganic salt can be yttrium (III) chloride (YCl₃), yttrium (III) fluoride (YF₃), yttrium (III) iodide (YI₃), yttrium (III) bromide (YBr₃), yttrium (III) nitrate tetrahydrate (Y(NO₃)₃.4H₂O), yttrium (III) nitrate hexahydrate (Y(NO₃)₃.6H₂O), yttrium (III) phosphate (YPO₄), yttrium (III) sulfate octahydrate (Y₂(SO₄)₂ 8H₂O), or any combination thereof.

For each mole of vanadium oxide (V₂O₅) present in the system, only about 2.5 moles of vanadium-related ash product is generated (2 moles of yttrium vanadate, YVO₄; and 0.5 moles of yttrium oxide, Y₂O₃), contributing to a lower ash volume than when magnesium is the inhibitor. The ash has a density of about 4.2 g/cc, which is higher than the density of magnesium-generated ash, also contributing to a lower ash volume. By binding most, all, or substantially all the vanadium present, yttrium as an inhibitor allows the reaction between lead oxide and sulfur oxide to take place, which leads to the formation of the higher melting point lead sulfate (PbSO₄) compound, thereby mitigating the direct corrosion by molten lead oxide. Lead sulfate melts at 1087° C., whereas lead oxide melts at 888° C. Finally, the inclusion of yttrium as an inhibitor allows nickel, typically present in heavy fuel oil, to convert to nickel sulfate, which is stable up to 1066° C. and is water soluble, making the nickel-containing ash water-soluble.

The chemical mixture can permit the operation of a gas turbine with an unrefined or poorly-refined fuel, including, but not limited to, heavy fuel oil or crude oil, that would otherwise be impractical as a fuel in a gas turbine. In some embodiments, the unrefined or poorly-refined fuel contains between about 90 ppm and about 200 ppm of vanadium compounds. In these embodiments, the chemical mixture is supplied at a rate sufficient to inhibit vanadium hot corrosion in the gas turbine caused by vanadium in the fuel to the gas turbine by converting all or substantially all of the vanadium to yttrium vanadate.

In some embodiments, a gas turbine process includes supplying a fuel to a gas turbine, combusting the fuel in the gas turbine, and supplying a chemical mixture including at least one yttrium-containing inorganic compound to the hot gas path. The fuel includes vanadium as a fuel impurity. The gas turbine has a hot gas path reaching a maximum temperature of about 1100° C. to about 1500° C. during operation of the gas turbine. The hot gas path decreases in temperature from the maximum temperature to preferably about 700° C. or lower by the last stage bucket of the gas turbine. A reduction in ash deposition and a reduction in the corrosion depth were demonstrated during testing with yttrium as an inhibitor at a lower temperature (685° C.). The chemical mixture is applied to the hot gas path of the gas turbine to inhibit vanadium hot corrosion in the gas turbine that would otherwise be caused by the vanadium in the fuel.

The gas turbine process can further include determining a concentration of at least one impurity in the fuel. In some embodiments, the impurity is vanadium. In other embodiments, the impurity is sodium, potassium, vanadium, lead, nickel, or any combination thereof. The concentration of the impurity in the fuel may be determined by one or more of any appropriate characterization techniques. In such embodiments, the rate or amount of the chemical mixture introduced to the hot gas path or to the fuel is selected based on the determined concentration of the at least one impurity in the fuel. In such embodiments, the rate or amount of the inhibitor composition is preferably selected to provide a predetermined ratio between at least one component in the chemical mixture and the impurity quantified in the fuel.

In some embodiments, the chemical mixture is applied to the hot gas path as part of the fuel itself. In other embodiments, the chemical mixture is applied directly to the hot gas path as a separate feed input. In some embodiments, the chemical mixture is injected into the hot gas path of the gas turbine through existing turbine casing openings such as borescope openings. In some embodiments, the chemical mixture is injected into the combustor of the gas turbine. In some embodiments, the chemical mixture is combined with the fuel prior to introduction of the fuel into the combustor. In some embodiments, the chemical reactant is first dissolved or dispersed in water using a mixing chamber before being injected into the hot gas path or combined with the fuel prior to introduction of the fuel into the combustor. In some embodiments, the chemical mixture includes a yttrium salt dissolved in water and then mixed into the fuel. In some embodiments, the yttrium salt dissolved in water is directly injected into the combustion chamber. In some embodiments, the chemical mixture is injected in the water injection system of the gas turbine. In some embodiments, the chemical mixture is injected into the hot gas path of the gas turbine through existing turbine casing openings, such as borescope openings, using air and retractable or stationary atomizing nozzles mounted to a retractable or stationary manifold.

The fuel can include heavy fuel oil or crude oil. The fuel impurities may also include sodium, potassium, lead, nickel, or combinations thereof. The chemical mixture inhibits corrosion caused by the at least one contaminant in the fuel in a hot gas path of a gas turbine. In some embodiments, the system includes sulfur or a sulfate as a fuel impurity or as part of the chemical mixture, preferably in an amount sufficient to react with any lead or nickel in the system.

The chemical mixture can be applied to the hot gas path at an inhibition rate to inhibit vanadium hot corrosion in the gas turbine caused by vanadium in a fuel to the gas turbine by converting all or substantially all of the vanadium to yttrium vanadate, YVO₄. The fuel can include heavy fuel oil or crude oil. A fuel composition includes a fuel with at least one fuel impurity including vanadium and a chemical mixture including at least one yttrium-containing inorganic compound. An atomic ratio of yttrium to vanadium in the fuel composition is in the range of 1 to 1.5, alternatively in the range of 1.1 to 1.4, or alternatively in the range of 1.2 to 1.3.

Other elements, including, but not limited to, bismuth, antimony, and sodium, react with vanadium and may be included in an chemical mixture. These elements also form vanadates but the reaction compounds have lower melting points, making them less desirable as inhibitors in high-temperature gas turbine systems. Yttrium may also be supplied as part of an organic compound, but with a typical rate of consumption of hundreds of pounds per machine per day, such compounds become extremely expensive as inhibitors.

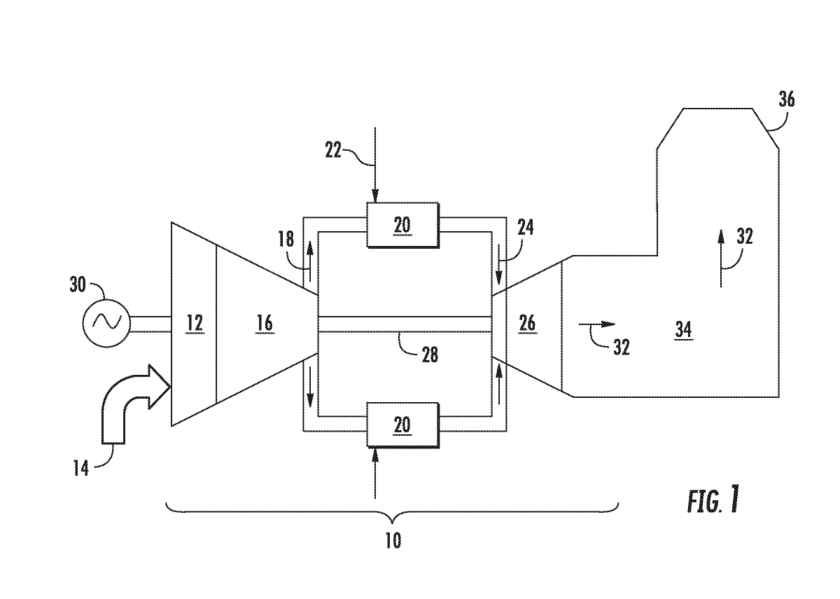

Referring now to the drawings, wherein identical numerals indicate the same elements throughout the figures, FIG. 1 provides a functional block diagram of an exemplary gas turbine 10 that may incorporate various embodiments of the present invention. As shown, the gas turbine 10 generally includes an inlet section 12 that may include a series of filters, cooling coils, moisture separators, and/or other devices to purify and otherwise condition a working fluid (e.g., air) 14 entering the gas turbine 10. The working fluid 14 flows to a compressor section where a compressor 16 progressively imparts kinetic energy to the working fluid 14 to produce a compressed working fluid 18 at a highly energized state. The compressed working fluid 18 flows to a combustion section where one or more combustors 20 ignite fuel 22 with the compressed working fluid 18 to produce combustion gases 24 having a high temperature and pressure. The combustion gases 24 flow through a turbine section to produce work. For example, a turbine 26 may connect to a shaft 28 so that rotation of the turbine 26 drives the compressor 16 to produce the compressed working fluid 18. Alternately or in addition, the shaft 28 may connect the turbine 26 to a generator 30 for producing electricity. Exhaust gases 32 from the turbine 26 flow through an exhaust section 34 that may connect the turbine 26 to an exhaust stack 36 downstream from the turbine 26. The exhaust section 34 may include, for example, a heat recovery steam generator (not shown) for cleaning and extracting additional heat from the exhaust gases 32 prior to release to the environment.

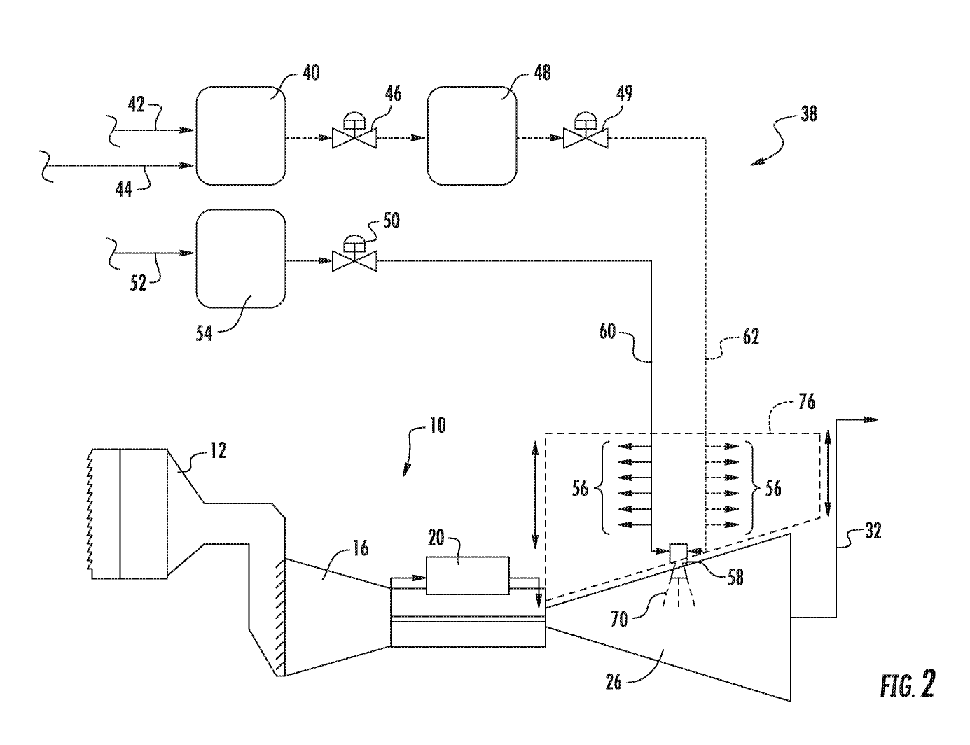

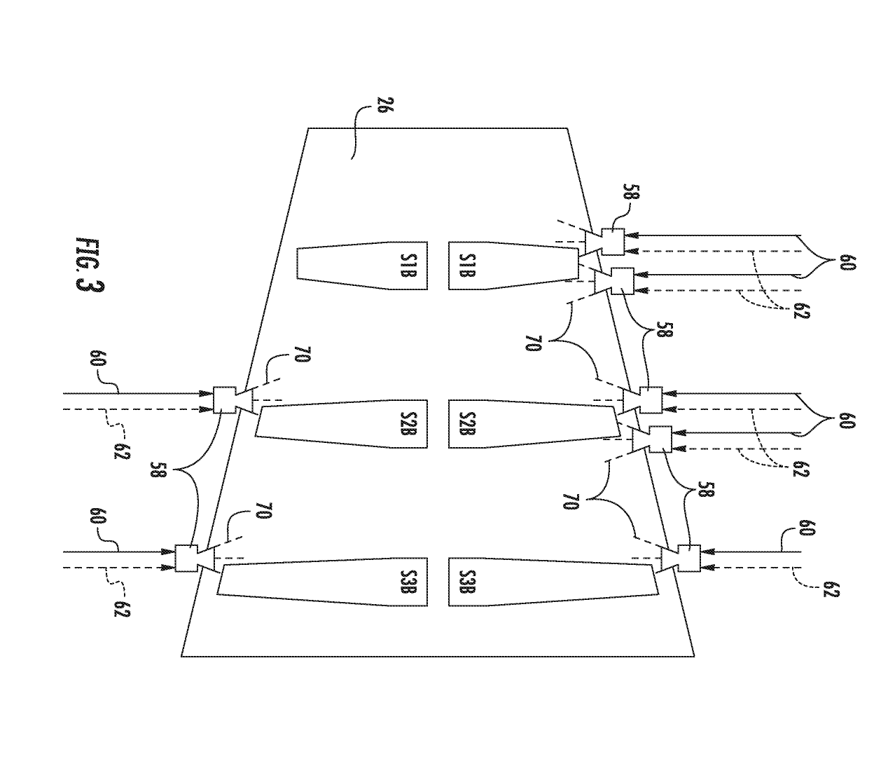

FIG. 2 is a schematic of an exemplary embodiment of a gas turbine injection system 38 serving a gas turbine 10 having an inlet section 12, a compressor section 16, at least one combustor 20 in a combustion section, and a turbine section 26. Air supply piping 60 is in fluid communication with a supply of air 52 and at least one spray nozzle 58. Water supply piping is in fluid communication with a supply of water 42 and chemical reactant supply piping in fluid communication with the supply of a chemical reactant 44. A mixing chamber 40 is in fluid communication with the water supply piping and the chemical reactant supply piping. The mixing chamber 40 is configured to receive water from the water supply piping and the chemical reactant from the chemical reactant supply piping to produce a chemical mixture 62. Chemical mixture 62 supply piping is in fluid communication with the mixing chamber 40 and the at least one spray nozzle 58. A retractable or stationary manifold 76 and/or retractable or stationary nozzles can be in fluid communication with the at least one spray nozzle 58, the chemical mixture supply piping 62, and the air supply piping 60. The at least one spray nozzle 58 is configured to selectively combine the chemical mixture 62 with the air 60 and inject an atomized chemical mixture 70 into at least one section of the turbine 26. The chemical mixture 62 supply piping can include a shut-off valve 46, a strainer 48 and a liquid pressure regulator valve 49. The filtered air 60 can include an air filter 54 and an air pressure regulator valve 50. Additional spray nozzles 56 can be located at various stages of the turbine 26 as well as in the combustors 20. FIG. 3 shows the spray nozzles 58 installed at multiple stages of the turbine 26 in accordance with an embodiment of the invention.

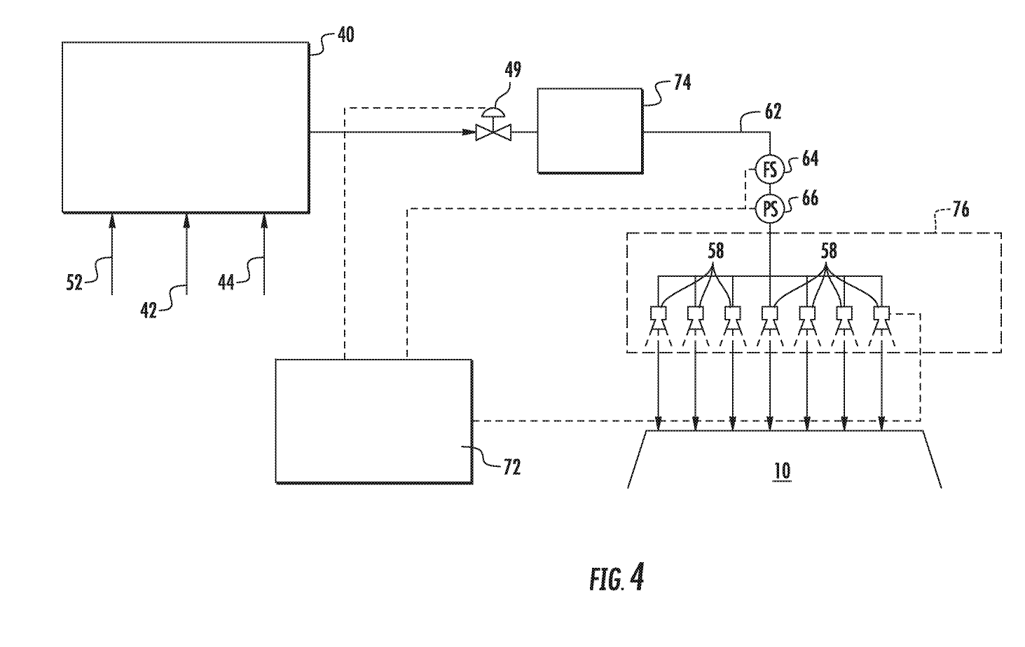

FIG. 4 shows an embodiment with air 52, water 42, and chemical reactant 44 feeding the mixing chamber 40. The mixing chamber 40 then mixes the chemical mixture 62 that is supplied to spray nozzles 58 at various turbine 26 and/or combustor 20 locations. A retractable manifold 76 can be in fluid communication with the at least one retractable spray nozzle 58, for example a Martin SMART Series retractable nozzle or BETE retractable lance, and the chemical mixture supply piping 62. The chemical mixture 62 can be filtered by a filtration system 74 that can be self-cleaning or cleaned manually. The chemical mixture 62 is controlled by an injection control circuit 72 that uses inputs from at least one of a pressure sensor 66 and flow sensor 64 to condition a control signal sent to a liquid pressure regulator 49 to maintain a predetermined setpoint. The control logic in the injection control circuit 72 can include an input determining the concentration of at least one impurity in the fuel 22 fed to the at least one combustor 20. In some embodiments, the fuel 22 impurity is vanadium. In other embodiments, the fuel 22 impurity is sodium, potassium, vanadium, lead, nickel, or any combination thereof. The concentration of the impurity in the fuel 22 may be determined by one or more of any appropriate characterization techniques. In such embodiments, the rate or amount of the chemical mixture 62 introduced to the hot gas path or to the fuel 22 is controlled by the control circuit 72 based on the determined concentration of the at least one impurity in the fuel 22. In such embodiments, the rate or amount of the chemical reactant 44 is preferably selected to provide a predetermined ratio between at least one component in the chemical mixture and the impurity quantified in the fuel 22.

Other embodiments of the control circuit initially shuts-down the turbine and allows the wheel space temperature to drop <149° F. before performing chemical injection. During injection, the turbine is rotated by the turning gear. Optionally, chemical injection can be performed at some predetermined crank speed during ignition and warm-up. The crank speed will be maintained until the chemical injection cycle is complete. The chemical injection cycle can include rinsing (spraying) using demineralized water alone and/or some predefined chemical mixture, then drying the wheel space and rinsed components, then re-starting the turbine similar to an offline water wash system used on the compressor section of the turbine. It is also beneficial to perform chemical injection in the turbine section while cleaning soap is being injected into the compressor section.

The control circuit 72 can be manually or automatically operated as desired by the user and as appropriate for the particular application or mode of operation when the gas turbine is either off-line or on-line. The control circuit 72 is suitably programmed so that an operator is not capable of making alterations to the ratio of the chemical reactant to water, the cycle times for the chemical injection cycle, or the order of steps in wash, rinse or chemical injection cycle. In an embodiment, such aspects of the chemical injection methods will be selected by the turbine manufacturer to accommodate the particular specifications and configuration of the gas turbine being treated.

The control circuit 72 can communicate, via communication links, with various pressure sensors 66 and flow sensors 64, and further communicates with actuation mechanisms (not all shown) to provide start, stop or control the speed of turbine components, and to open, close, or regulate the position of valves 46, 49, 50, 56, and 58 as required to accomplish the chemical injection operations. Communication links are implemented in hardware and/or software. In one embodiment, communication links remotely communicate data signals to and from the control circuit 72 in accordance with conventional wired or wireless communication protocol. Such data signals include, but are not limited to, signals indicative of operating conditions of the various sensors transmitted to the control circuit 72 and/or various command signals communicated by the control circuit 72.

In an embodiment, the control circuit 72 is a computer system that includes a control panel/display, a controller, and at least one processor. The control circuit 72 executes programs to control operations of the gas turbine 10 using sensor inputs and instructions from human operators. User input functionality is provided in the control panel/display, which acts as a user input selection device, as well as a display of the operating conditions of the various components of the gas turbine 10.

As used herein, the term processor is not limited to just those integrated circuits referred to in the art as a computer, but broadly refers to a microcontroller, a microcomputer, a programmable logic controller (PLC), an application specific integrated circuit, and other programmable circuits, and these terms are used interchangeably herein. In the embodiments described herein, memory includes, but is not limited to, a computer-readable medium, such as a random access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) are utilized. Also, in the embodiments described herein, additional input channels include, but are not limited to, computer peripherals associated with an operator interface such as a mouse and a keyboard. Alternatively, other computer peripherals are employed which include, for example, but not be limited to, a scanner. Furthermore, in an embodiment, additional output channels include, but are not limited to, an operator interface monitor.

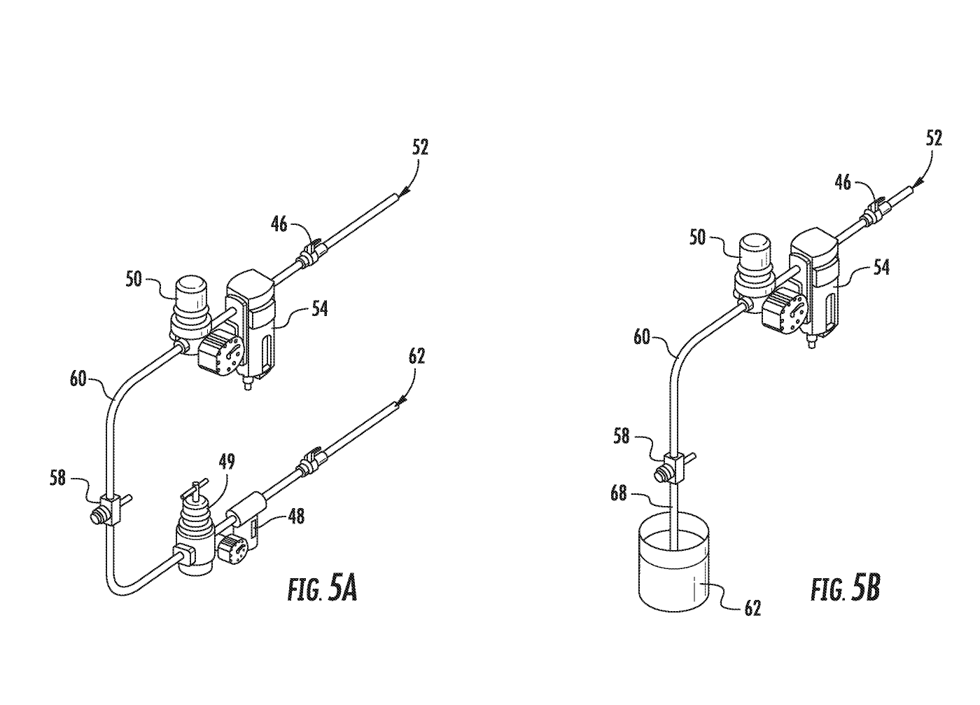

FIGS. 5A and 5B show embodiments of the spray nozzles 58 using atomizing-type nozzles fed by filtered air 60 and chemical mixture 62 to atomize the chemical mixture 62 as it leaves the spray nozzle 58 and enters the turbine 26. In FIG. 5A, the chemical mixture 62 liquid piping feeds through a strainer 48 and a liquid pressure regulator 49 before entering the atomizing spray nozzle 58 where it is atomized by the filtered air 60 and sprayed into the turbine 26. In FIG. 5B, the chemical mixture 62 is siphoned from a container into the atomizing spray nozzle 58 where it is atomized by the filtered air 60 and sprayed into the turbine 26.

This written description uses examples to disclose the invention, including the best mode, and also to enable any person skilled in the art to practice the invention, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A gas turbine injection system, comprising:
a gas turbine having an inlet section, a compressor section, at least one combustor in a combustion section, and a turbine section;
air supply piping in fluid communication with a supply of air and at least one spray nozzle;
water supply piping in fluid communication with a supply of water;
chemical reactant supply piping in fluid communication with the supply of a chemical reactant;
a mixing chamber in fluid communication with the water supply piping and the chemical reactant supply piping, the mixing chamber configured to receive water from the water supply piping and the chemical reactant from the chemical reactant supply piping to produce a chemical mixture; and
chemical mixture supply piping in fluid communication with the mixing chamber and the at least one spray nozzle, the at least one spray nozzle configured to selectively combine the chemical mixture with the air and inject an atomized chemical mixture into at least one section of the turbine.

2. The injection system of claim 1, further comprising a retractable manifold in fluid communication with at least one retractable spray nozzle, the chemical mixture supply piping, and the air supply piping.

3. The injection system of claim 1, wherein the at least one spray nozzle is removably disposed in at least one casing opening selected from the group consisting of borescope ports, late lean injection ports, combustor premix manifold, combustor purge air manifold, and mixtures thereof.

4. The injection system of claim 1, further comprising a control circuit configured to determine a fuel impurity concentration of at least one fuel impurity in a fuel supplied to the combustor during a chemical injection cycle.

5. The injection system of claim 4, wherein the control circuit maintains a predetermined ratio between at least one component of the chemical mixture and the fuel impurity concentration.

6. The injection system of claim 4, wherein the fuel impurity is at least one of vanadium, sodium, potassium, lead, nickel, and mixtures thereof.

7. The injection system of claim 1, wherein the at least one retractable spray nozzle is an atomizing nozzle.

8. The injection system of claim 1, wherein the chemical reactant comprises at least one of magnesium, yttrium, neutralizing amine compound, polyamine solution, a compatibilizer, demineralized water and mixtures thereof.

9. The injection system of claim 8, wherein the yttrium is in the form of an inorganic salt, an inorganic salt powder, an inorganic salt dissolved in water as a nitrate or a sulfate, an inorganic salt in a fuel-soluble form, and mixtures thereof.

10. A gas turbine injection system, comprising:
a gas turbine having an inlet section, a compressor section, at least one combustor in a combustion section, and a turbine section;
air supply piping in fluid communication with a supply of air and a mixing chamber;
water supply piping in fluid communication with a supply of water and the mixing chamber;
chemical reactant supply piping in fluid communication with the supply of a chemical reactant and the mixing chamber; and
wherein the mixing chamber is configured to mix the air, water, and chemical reactant to produce a chemical mixture fed in chemical mixture supply piping to at least one spray nozzle configured to inject the chemical mixture into at least one section of the turbine.

11. The injection system of claim 10, further comprising a retractable manifold in fluid communication with at least one retractable spray nozzle and the chemical mixture supply piping.

12. The injection system of claim 10, wherein the at least one spray nozzle is removably disposed in at least one casing opening selected from the group consisting of borescope ports, late lean injection ports, combustor premix manifold, combustor purge air manifold, and mixtures thereof.

13. The injection system of claim 10, further comprising a control circuit configured to determine at least one of a fuel impurity concentration of at least one fuel impurity in a fuel supplied to the combustor, a chemical mixture flow rate, and a chemical mixture pressure.

14. The injection system of claim 13, wherein the control circuit maintains a predetermined ratio between at least one component of the chemical mixture and the fuel impurity concentration during a chemical injection cycle.

15. The injection system of claim 13, wherein the fuel impurity is at least one of vanadium, sodium, potassium, lead, nickel, and mixtures thereof.

16. The injection system of claim 10, wherein the chemical reactant comprises at least one of magnesium, yttrium, neutralizing amine compound, polyamine solution, a compatibilizer, demineralized water, and mixtures thereof.

17. The injection system of claim 16, wherein the yttrium is in the form of an inorganic salt, an inorganic salt powder, an inorganic salt dissolved in water as a nitrate or a sulfate, an inorganic salt in a fuel-soluble form, and mixtures thereof.

18. The injection system of claim 10, further comprising a chemical mixture filtration system.

19. A chemical injection method for reducing turbine degradation, comprising the steps of:
generating a chemical mixture in a mixing chamber, and
injecting the chemical mixture comprising at least one yttrium-containing compound to at least one section of a gas turbine using a gas turbine injection system comprising:
air supply piping in fluid communication with a supply of air and at least one spray nozzle;
water supply piping in fluid communication with a supply of water;
chemical reactant supply piping in fluid communication with the supply of a chemical reactant;
wherein the mixing chamber is in fluid communication with the water supply piping and the chemical reactant supply piping, the mixing chamber configured to receive water from the water supply piping and the chemical reactant from the chemical reactant supply piping to produce the chemical mixture; and
chemical mixture supply piping is in fluid communication with the mixing chamber and the at least one spray nozzle, the at least one spray nozzle configured to selectively combine the chemical mixture with the air and inject an atomized chemical mixture into at least one section of the turbine.

20. The method of claim 19, wherein the chemical reactant comprises at least one of magnesium, yttrium, neutralizing amine compound, polyamine solution, a compatibilizer, demineralized water, and mixtures thereof.
